(19) United States
(12) Patent Application Publication
(10) Pub. No.: US 2022/0186601 A1
(43) Pub. Date: Jun. 16, 2022

(54) METHOD FOR OBTAINING OVERALL LOGGING DATA BASED ON AUTOMATED REASONING MODEL

(71) Applicant: Zhejiang University City College, Hanhzhou (CN)

(72) Inventors: Wenyong WENG, Hangzhou (CN); Yin LU, Hangzhou (CN); Wujian YANG, Hangzhou (CN); Qing MA, Hangzhou (CN); Guanlin CHEN, Hangzhou (CN)

(21) Appl. No.: 17/548,608

(22) Filed: Dec. 13, 2021

(30) Foreign Application Priority Data
Dec. 16, 2020 (CN) 202011489321.4

(51) Int. Cl. E21B 47/002; E21B 47/005; E21B 47/06

(52) U.S. Cl. CPC E21B 47/0025; E21B 2200/22; E21B 47/06; E21B 47/005

(57) ABSTRACT

A method for obtaining overall logging data based on an automated reasoning model is provided. The method achieves a reservoir evaluation for a reservoir matrix within a multi-depth range by generating high-quality point location prediction data. The method includes: acquiring imaging logging data and lab observing data of a stratum; inputting the imaging logging data and the lab observing data, to form dimensionless data and performing data normalization on the data; denoising known continuous data; marking a to-be-supplemented data point location; performing data supplementing for a point location in a predetermined order; and restoring a data dimension to obtain the overall logging data by supplementing. By automatically supplementing the lab observing data in analysis logging data, high-quality prediction data is obtained, which provides a basis for subsequent evaluation and analysis of the stratum, and contributes to exploration and development of resources such as oil, gas, and coal.

### CROSS-REFERENCE TO RELATED APPLICATION

The present application claims priority to Chinese Patent Application No. 202011489321.4, filed on Dec. 16, 2020, the content of which is incorporated herein by reference in its entirety.

### TECHNICAL FIELD

The application relates to a method for obtaining overall logging data based on an automated reasoning model. Particularly, the application relates to a method for obtaining the overall logging data by simulated supplementing in which a part with data missing in the logging data is supplemented, to realize analyzing and classifying geology phases of rock stratum in a multi-depth scope.

### BACKGROUND

Logging, also called geophysical well logging, is a method for measuring geophysical parameters with geophysical properties of the rock stratum, such as an electrochemical property, a conductive property, an acoustic property, radioactivity, and the like. Imaging logging is currently the most commonly used method. The logging method makes it possible to obtain a large amount of physicochemical property data of the rock stratum, thus providing a basis for analyzing stratum and other tasks. In order to better research and analyze the stratum, during a logging process, some rock core segments may be acquired for observing, analyzing, and researching. In addition, other properties may be learned, such as an age property, lithology, dispositional property of the stratum, physical and chemical properties, an oil content, a gas content, and a water content of the stratum, underground construction (e.g. faultage, jointing, and a tendency and a tilt angle thereof), motion and distribution of oil, gas, and water, and variation of stratigraphic texture.

It requires a lot of time and labor to observe and analyze the rock core in a lab. It is impossible to observe and analyze the entire well in the lab. Therefore, predicting and supplementing related parameters of other positions by numerical simulation may assist in subsequent stratigraphic analysis. Currently, there is little research on supplementing method of logging data, and a method based on linear regression is mainly applied. However, since there are much more point locations with data missing than those with data, those methods are generally not satisfactory in data supplementing, and cannot effectively assist in subsequent analysis such as reservoir evaluation of a reservoir stratum matrix.

### SUMMARY

A method for obtaining overall logging data based on an automated reasoning model is provided in the present application. In the present application, by inputted imaging logging data and other data obtained by lab observing method and the like, automatically supplementing missing data of point locations, to obtain overall logging data, and analyze and classify geological phases of a rock stratum.

A technical solution in the present application is as follows.

A method for obtaining overall logging data based on an automated reasoning model includes:

step (1), acquiring imaging logging data and lab observing data of a stratum;

step (2), performing data normalization on the imaging logging data and the lab observing data, to form dimensionless data;

step (3), denoising continuous data obtained by the step (2), to obtain denoised data;

step (4), automatically marking a to-be-supplemented data point location of the denoised data obtained by the step (3) according to an interval between known point locations of a same type data as the denoised data;

step (5), performing reasoning on the to-be-supplemented data point location marked in the step (4), to automatically generate data for the to-be-supplemented data point location; specifically including:
generating a bigram (Ŷ, P) for each to-be-supplemented data point location, wherein Ŷ represents a potential value of a current to-be-supplemented data point location, and P represents a probability of taking a value of the current to-be-supplemented data point location as Ŷ; taking Ŷ with a maximum probability in the bigram as a prediction value of the to-be-supplemented data point location, to complete data supplementation; and wherein the generating a bigram (Ŷ, P) for each to-be-supplemented data point location includes
   (a) selecting values of data items in the normalized imaging logging data and values of data items in the normalized lab observing data, to form a list of Ŷ in the bigram;
   (b) taking other known data items of the to-be-supplemented data point location v to form a set DSᵥ={D₁, D₂, . . . , Dₘ}, wherein m represents a number of supplemented data items;
   (c) taking, from a current logging data set, data of R/20 point locations with a smallest distance away from the set DSᵥ, to form a set ITEMₐ; taking, from historical data, data of R point locations with a smallest distance away from the set DSᵥ to form a set ITEM_{b}, wherein R is the number of point locations in the current logging data set, and a distance between another point location and a current point location is a sum of absolute values of differences between respective known data items of the two point locations; and
   (d) calculating by the following equation: P_{Ŷ}=(Number of times Ŷ appearing in ITEMₐ*20+Number of times Ŷ appearing in ITEM_{b})/2R; and

step (6) performing data post-processing to restore a data dimension, to obtain the overall logging data by supplementing.

Further, the step (2) includes:

for each data item in the imaging logging data and the lab observing data, converting the data item to an integer from 0 to 10000 according to a predetermined rule, wherein a depth in the data item is converted to a continuous integer from 0 to N, a remaining quantitative value is converted by projection according to the rule based on a defined extremum, and a qualitative value is converted according to a preset value.

Further, converting the quantitative value by projection according to the rule based on a defined extremum includes: converting the quantitative by linear projection and logarithm projection. Herein, linear projection may be used in a case that data points are distributed relatively uniformly, while logarithm projection may be used in a case that the data points are distributed densely locally.

Further, in the step (3), two-dimensional curve fitting and a curvature extremum peak-removing may be used for denoising.

Further, the step (3) includes:

(3.1) for each known data item, taking a depth as an X coordinate, and the normalized other data as a Y coordinate, to calculate a break change rate SIₓ of each coordinate, and to form a break change rate vector (S1ₓ, S2ₓ, . . . ,SMₓ) for a point location, wherein the break change rate SIₓ is calculated by:

SIₓ=[(Yₓ−Yₓ₋₃)*0.2+(Yₓ−Yₓ₋₂)*0.3+(Yₓ−Yₓ₋₁)*0.5]/(Yₘₐₓ−Yₘᵢₙ)X>Xₘᵢₙ+2

SIₓ=[(Yₓ−Yₓ₋₂)*0.4+(Yₓ−Yₓ₋₁)*0.6]/(Yₘₐₓ−Yₘᵢₙ)X=Xₘᵢₙ+2

SIₓ=(Yₓ−Yₓ₋₁)/(Yₘₐₓ−Yₘᵢₙ)X=Xₘᵢₙ+1

where Yₓ represents a value of a data item at an X coordinate position, Yₘₐₓ represents a maximum of the data item, Yₘᵢₙ represents a minimum of the data item, Xₘᵢₙ represents a minimum of the X coordinate, I=1, 2, . . . , M, and M is a number of data items;

(3.2) forming an M*N matrix for the break change rate by the break change rates for all the point locations, and performing normalization in unit of row, wherein M is the number of data items, and N is the number of point locations;

(3.3) identifying a noise point according to the matrix, specifically including:
(3.3.1) for each element S′iⱼ in the normalized matrix, calculating a difference coefficient Kᵢⱼ of the element, a value of the difference coefficient is an absolute value of a sum of differences between S′iⱼ and respective elements in a column in which this element S′iⱼ is located/(M−1), to form a matrix K, wherein i=1,2, . . . , M, and j=1,2, . . . , N;
(3.3.2) for each row in the matrix K, calculating an average K_{avg} and a maximum Kₘₐₓ, and the number of point locations for Kᵢⱼ in an interval [Kₘₐₓ−(Kₘₐₓ−K_{avg})/10,Kₘₐₓ]; if the number of point locations is larger than N/20, determining that there is no abnormal point location in this row, or else performing (3.3.3);
(3.3.3) extracting a point location in a case of Kij≥Kmax; if the number of the extracted point locations is smaller than or equal to 3, marking the extracted point locations to be abnormal points and performing (3.3.4); if the number of the extracted point locations is larger than 3, ending the identifying; and
(3.3.4) in a case that Kmax=Kmax−(Kmax−Kavg)/100, removing data of an identified abnormal point location and performing (3.3.3); and

(3.4) Substituting Point Location Data of the Noise Point.

Further, the step (3.4) includes: for an abnormal point location k, extracting data Y_{c} for a former normal point location and data Y_{d} for a next normal point location, to determine a data value of the abnormal point location k to be Yₖ=Y_{c}+(Y_{d}−Y_{c})*(k−c)/(d−c).

Further, two-dimensional curve fitting and a curvature extremum peak-removing are used to remove a noise point.

Further, the step (4) further includes: determining a supplementing order, including:

(A) calculating a data completeness for each data item, wherein the data completeness includes a ratio of the number of known data point locations which have been in the order to the total number of the point locations; and

(B) for a data item with the lowest completeness, selecting, from the to-be-supplemented data point locations of this data item, a point location with a smallest distance away from an existing data point location and adding to a task list; and re-calculating the data completeness of this data item, and performing (B) repeatedly, until the order determining is completed.

One of the advantages of the present application is as follows. In the present application, automatically supplementing is performed on the lab observing data, thus obtaining the overall logging data and achieving analysis and classifying to geology phases of stratum within a multi-depth range. During the data supplementing, denoising is performed on known data in the present application, increasing availability of source data. With a probabilistic method, an algorithm with a controllable calculating complexity is achieved, prediction data with a relatively high quality is obtained, and a supplementing effectiveness for missing data is increased, which provides a basis for subsequent analysis. Thus, a reliability of stratum analysis is obtained, which contributes to exploration and development of resources such as oil, gas and coal.

### BRIEF DESCRIPTION OF DRAWINGS

FIG. 1 is a flow chart of a method for obtaining overall logging data based on an automated reasoning model; and

FIG. 2 is a schematic diagram showing the noisy point identifying process and data transforming process.

### DESCRIPTION OF EMBODIMENTS

Further description of the present application will be made in connection with detailed embodiments and accompanying drawings below.

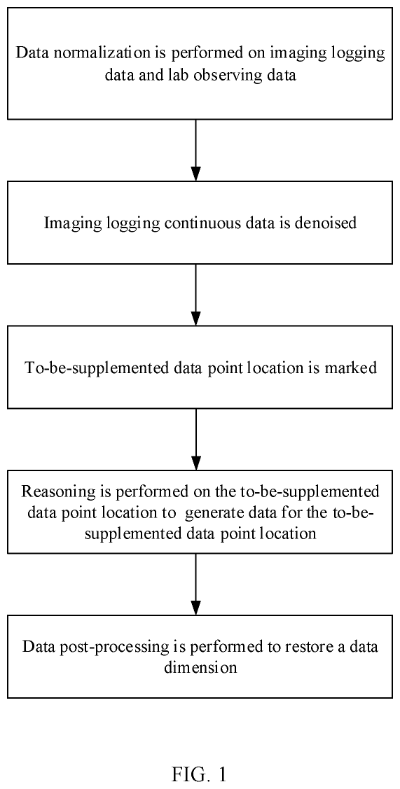

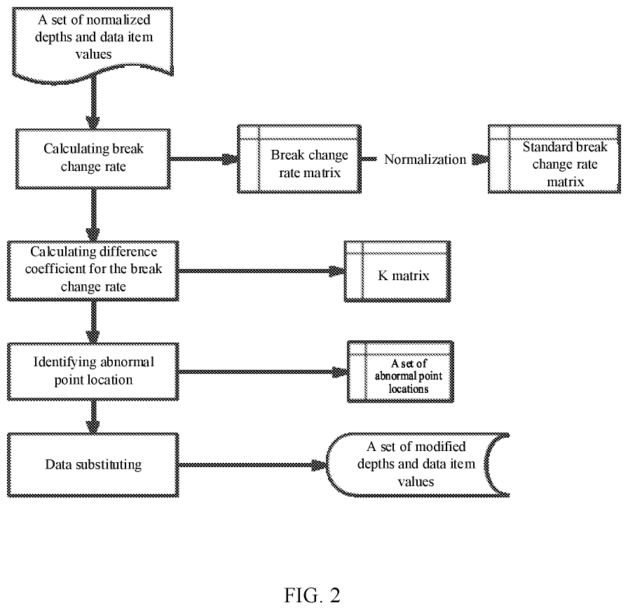

The present application provides a method for obtaining overall logging data based on an automated reasoning model. By acquiring imaging logging data and lab observing data of the reservoir stratum, the lab observing data is supplemented by applying an automatic supplementing method for the logging data based on the automated reasoning model, to obtain the overall logging data. Herein, the imaging logging data includes BIT, CAL, DAZOD, DEVOD, GR, M2R1, M2R2, M2R3, M2R6, M2R9, M2RX, SPDH, CNC, KTH, ZDEN, DTC, DTS, DTST, PR, VPVS, YXHD, PERM, PORO, VSH, SO and the like, and the lab observing data includes a cement condition, core POR, core PERM, a total plane porosity, a dissolved pore space, an average throat radius, a contribution throat radius, a displacement pressure. By the overall data of a rock segment obtained by the supplementing, it is possible to perform determination and classifying to geology items of the rock stratum, such as classifying and evaluation in reservoir of the rock stratum, to identify reserve stratum of a high quality. A method for obtaining overall logging data based on an automated reasoning model is provided in the present application, and the method includes the following steps (as shown in FIGS. 1-2).

1. Data Normalization Process

For all data items, normalization rules are predefined. According to a status of original data, two rules may be used for normalization as follows.

a. A quantitative data transform rule is defined by a triple R=(RT, MIN, MAX), where RT represents a projection rule, MIN represents a minimum in the original data, and MAX represents a maximum in the original data. Currently, RT may be 1 or 2. Herein, linear projection may be used in a case that data points are distributed relatively uniformly, while logarithm projection may be used in a case that the data points are distributed densely locally.

The transforming may be performed by the linear projection in a case of RT=1, and a normalized value D of the original data S may be calculated by the following equation:

D=10000*(S−MIN)/(MAX−MIN); where D is obtained by rounding-off.

The transforming may be performed by the logarithm projection in a case of RT=2, and a normalized value D of the original data S may be calculated by the following equation:

D=10000*lg(S−MIN)/lg(MAX−MIN); where D is obtained by rounding-off.

b. In a qualitative data transform rule, data transforming is performed by enumeration, namely for each possible qualitative value, a value from 0 to 10000 is obtained by projection.

c. All the depths are transformed into consecutive integers from small to large.

2. Denoising of Continuous Data

Data denoising is performed on each data item covering an entire depth range of the well (a majority of imaging logging data is as such).

a. Taking a depth as the X coordinate, and the normalized data as the Y coordinate, a break change rate of each data item I (I=1, 2, . . . , M) for all the X coordinates is calculated as follows:

SIₓ=[(Yₓ−Yₓ₋₃)*0.2+(Yₓ−Yₓ₋₂)*0.3+(Yₓ−Yₓ₋₁)*0.5]/(Yₘₐₓ−Yₘᵢₙ)X>Xₘᵢₙ+2

SIₓ=[(Yₓ−Yₓ₋₂)*0.4+(Yₓ−Yₓ₋₁)*0.6]/(Yₘₐₓ−Yₘᵢₙ)X=Xₘᵢₙ+2

SIₓ=(Yₓ−Yₓ₋₁)/(Yₘₐₓ−Yₘᵢₙ)X=Xₘᵢₙ+1

where Yₓ represents a value of a data item at an X coordinate position, Yₘₐₓ represents a maximum of the data item, Yₘᵢₙ represents a minimum of the data item, and Xₘᵢₙ represents a minimum of the X coordinate.

b. For an X point location, all the data items thereof construct a break change rate vector, and a matrix for the break change rate as shown below is constructed by the break change rate vectors of all the point locations:

$$\begin{matrix}S {1}_{1} & S {1}_{2} & S {1}_{3} & S {1}_{4} & … & S {1}_{N} \\ S {2}_{1} & S {2}_{2} & S {2}_{3} & S {2}_{4} & … & S {2}_{N} \\ & & … & & & \\ {SM}_{1} & {SM}_{2} & {SM}_{3} & {SM}_{4} & … & {SM}_{N}\end{matrix}$$

M is the number of data items, and N is a number of point locations.

c. Normalization is performed on the matrix based on a unit of row, S′iⱼ=(Siⱼ−Siₘᵢₙ)/(Siₘₐₓ−Siₘᵢₙ), i=1,2, . . . ,M,j=1,2, . . . ,N, and a new matrix is formed as follows:

$$\begin{matrix}{S}^{′} {1}_{1} & {S}^{′} {1}_{2} & {S}^{′} {1}_{3} & {S}^{′} {1}_{4} & … & {S}^{′} {1}_{N} \\ {S}^{′} {2}_{1} & {S}^{′} {2}_{2} & {S}^{′} {2}_{3} & {S}^{′} {2}_{4} & … & {S}^{′} {2}_{N} \\ & & … & & & \\ {S}^{′} {M}_{1} & {S}^{′} {M}_{2} & {S}^{′} {M}_{3} & {S}^{′} {M}_{4} & … & {S}^{′} {M}_{N}\end{matrix}$$

d. In the above matrix, an abnormal break change rate is identified by the following identifying method.

In step 1, for each element in the new matrix, a difference coefficient Kᵢⱼ is calculated, a value of which is an absolute value of a sum of differences between S′iⱼ and respective elements in a column in which this element is located/(M−1), thus forming a matrix K.

In step 2, for each row in the matrix K, an average K_{avg} and a maximum Kₘₐₓ are calculated, and a number of point locations for Kᵢⱼ in an interval [Kₘₐₓ−(Kₘₐₓ−K_{avg})/10,Kₘₐₓ]. If the number of point locations is larger than N/20, it is determined that there is no abnormal point location in this row, or else step 3 is performed.

In step 3, a point location in which Kᵢⱼ≥Kₘₐₓ is extracted. If a number of the extracted point locations is smaller than or equal to 3, the extracted point locations are marked to be abnormal points and step 4 is performed. If the number of the extracted point locations is larger than 3, the identifying is ended.

In step 4, in a case that Kₘₐₓ=Kₘₐₓ−(Kₘₐₓ−K_{avg})/100, data of an identified abnormal point location is removed and the step 3 is performed.

e. The data of the abnormal point location identified in a former step is modified by: extracting data Y, for a former normal point location and data Y_{d} for a next normal point location are extracted to determine a data value Yₖ=Y_{c}+(Y_{d}−Y_{c})*(k−c)/(d−c) of the point location to be modified.

3. Marking of a to-be-Supplemented Data Point Location

A data item needed to be supplemented is generally in the lab observing data, which possesses a value only in part of the logging depth range, and other point locations thereof need to be performed the data supplementing. Before the data supplementing, it is necessary to mark a point location requiring the data supplementing. Marking of a point location is performed by taking a minimum depth interval of existing data in a data item to be a step length, and marking the point location in an empty region on a basis of point locations with the existing data.

After the marking, the to-be-supplemented data point location may be expressed by the following data structure:

Items=[item₁, item₂, . . . , itemₘ], where m represents a number of data items requiring the supplementing; and

Itemₜ=[X₁,X₂, . . . , Xₙ], where n represents a number of point locations of the t-th data item requiring the supplemented, and Xᵢ is a depth of the i-th point location. Since depths and step lengths of known data values for each data item are different from each other, respective numbers of values for respective data items are not identical, either.

After marking the point locations, it is necessary to determine a supplementing order for ranking. After the ranking, a reasoning task list may be expressed by an array representation of a bigram (ITEM, X), and in a subsequent reasoning algorithm, reasoning and calculating are performed by this order. The ranking is performed by the following steps.

In the first step, a data completeness of each data item, namely, a number of point locations of the existing data (including point locations which have been in the ranking) divided by a total number of point locations, is calculated.

In the second step, for a data item with the lowest completeness, a point location with a smallest distance away from an existing data point location is selected from the to-be-supplemented data point locations of this data item, and added to the task list. The data completeness of this data item is re-calculated, and the second step is performed repeatedly, until the ranking is completed.

4. Reasoning and Supplementing of Point Location Data

The data for supplementing is generated by an automated reasoning model. In the automated reasoning model, all the known values of the data items for the point location are applied in connection with historical experience reasoning, to obtain predicting data. In the model, data items for one point location are selected according to rules for reasoning.

a. an array PARR including all possible values is constructed for each data item to be reasoned, in which each node is stored with a bigram (Ŷ, P), where Ŷ represent a possible value, and P represents a probability of a value of a current to-be reasoned point location being Ŷ. In the array, a list of Ŷ values is selected according to the following rule: for a qualitative value, selecting all the enumeration values; for a quantitative value, selecting a fixed step length between 1 and 10000, where the step length is a preset value for a date item.

b. A bigram JOB=(ITEM, X) is selected from a list of reasoning tasks in order, and a probability P of each Ŷ in the PARR of a data item to which ITEM points is calculated by:

in a first step, taking other known data items of the current point location v to form a set DSᵥ={D₁,D₂, . . . ,Dₘ};

in a second step, taking all data of R/20 point locations with a smallest distance away from the set DSᵥ in a current logging data set, to form a set ITEMₐ; taking, from historical data (preferably larger than 50 logging data, including more than 10% of actual observing data), all data of R point locations with a smallest distance away from the set DSᵥ to form a set ITEM_{b}, where R is a number of current logging point locations, and a distance between another point location and the current point location is a sum of absolute values of differences between respective known data items of the two point locations.

in a third step, calculating a value of P_{Ŷ} by P_{Ŷ}=(Number of times the value Ŷ appearing in ITEMₐ*20+Number of times the value Ŷ appearing in ITEM_{b})/2R.

c. Ŷ with the maximum probability in PARR is determined as a prediction value of the point location. The step b is repeated to complete prediction of the remaining point locations.

5. Performing Data Post-Processing to Restore a Data Dimension

In this step, an inverse process of the normalization is performed, and the data dimension is restored after the process, so as to obtain the overall logging data by supplementing.

With the overall logging data obtained by the supplementing method of the present application, it is possible to analyze petrologic features including a lithlogy of the core, a clastic particle granularity of the core, a deposition construction of the core, an ancient stream type of a rock, a prosity of a rock, a penetrance of a rock, and a pore structure of a rock, and the like. For example, a reservoir evaluation of a reservoir matrix is performed with physical property data, supplemented pore throat data (a fraction of the surface vacancy, a radius of the pore throat, etc.), observed petrofacies data.

In the present application, the calculating complexity due to different data dimensions is simplified, and the efficiency may be increased. Moreover, since multiple normalization methods are used, it can be assured that data is distortionless. In the present application, a denoising method for continuous data is designed. In this method, abnormal data is marked by identifying a break change point location, which is advantageous to remove a point location affecting a stability of a prediction algorithm, and increase an accuracy of the prediction algorithm. In the present application, historical logging data is repeatedly used and data prediction is performed by a probabilistic method. It is possible to perform the prediction by historical data repeatedly and a calculating complexity can be controlled. With the application, data with a relatively high quality may be obtained, and an effectiveness of the supplementing for missing data is increased, thus achieving analysis for geofacies of the stratum within a multiple depth ranges for the reservoir matrix, and contributing to exploration and development of resources such as oil, gas, and coal.

The above embodiments are obviously made for explicitly illustrating examples as made, and are not intended to limit the implementations. Other variations and modifications may be made based on the above description by a person skilled in the art. It is not necessary and impossible to exhaust all the implementations here. Evident variations and modifications derived herefrom are still within a protection scope of the present application.

What is claimed is:

1. A method for obtaining overall logging data based on an automated reasoning model, comprising:
step (1), acquiring imaging logging data and lab observing data of a stratum;
step (2), performing data normalization on the imaging logging data and the lab observing data, to form dimensionless data;
step (3), denoising continuous data obtained by the step (2), to obtain denoised data;
step (4), automatically marking a to-be-supplemented data point location of the denoised data obtained by the step (3) according to an interval between known point locations of a same type data as the denoised data;
step (5), performing reasoning on the to-be-supplemented data point location marked in the step (4), to automatically generate data for the to-be-supplemented data point location, comprising:
generating a bigram (Ŷ, P) for each to-be-supplemented data point location, wherein Ŷ represents a potential value of a current to-be-supplemented data point location, and P represents a probability of taking a value of the current to-be-supplemented data point location as Ŷ; taking Ŷ with a maximum probability in the bigram as a prediction value of the to-be-supplemented data point location, to complete data supplementation; and wherein the generating a bigram (Ŷ, P) for each to-be-supplemented data point location comprises:
(a) selecting values of data items in the normalized imaging logging data and values of data items in the normalized lab observing data, to form a list of Ŷ in the bigram;
(b) taking other known data items of the to-be-supplemented data point location v to form a set DSᵥ={D₁, D₂, . . . , Dₘ}, wherein m represents a number of supplemented data items;
(c) taking, from a current logging data set, data of R/20 point locations with a smallest distance away from the set DSᵥ, to form a set ITEMₐ; taking, from historical data, data of R point locations with a smallest distance away from the set DSᵥ to form a set ITEM_{b}, wherein R is the number of point locations in the current logging data set, and a distance between another point location and a current point location is a sum of absolute values of differences between respective known data items of the two point locations; and
(d) calculating by a following equation: P_{Ŷ}=(Number of times Ŷ appearing in ITEMₐ*20+Number of times Ŷ appearing in ITEM_{b})/2R; and
step (6) performing data post-processing to restore a data dimension, to obtain supplemented overall logging data.

2. The method as claimed in claim 1, wherein the imaging logging data comprises BIT, CAL, DAZOD, DEVOD, GR, M2R1, M2R2, M2R3, M2R6, M2R9, M2RX, SPDH, CNC, KTH, ZDEN, DTC, DTS, DTST, PR, VPVS, YXHD, PERM, PORO, VSH, SO, and the lab observing data comprises a cement condition, core POR, core PERM, a total plane porosity, a dissolved pore space, an average throat radius, a contribution throat radius, a displacement pressure.

3. The method as claimed in claim 1, wherein the step (2) comprises:
for each data item in the imaging logging data and the lab observing data, converting the data item to an integer from 0 to 10000 according to a predetermined rule, wherein a depth in the data item is converted to a continuous integer from 0 to N, a remaining quantitative value is converted by projection according to the rule based on a defined extremum, and a qualitative value is converted according to a preset value.

4. The method as claimed in claim 3, wherein the quantitative value is converted by linear projection and logarithm projection according to the rule based on a defined extremum.

5. The method as claimed in claim 1, wherein the step (3) comprises:
(3.1) for each known data item, taking a depth as an X coordinate, and normalized other data as a Y coordinate, to calculate a break change rate SIₓ of each coordinate, and to form a break change rate vector (S1ₓ, S2ₓ, . . . ,SMₓ) for a point location, wherein the break change rate SIₓ is calculated by:
SIₓ=[(Yₓ−Yₓ₋₃)*0.2+(Yₓ−Yₓ₋₂)*0.3+(Yₓ−Yₓ₋₁)*0.5]/(Yₘₐₓ−Yₘᵢₙ)X>Xₘᵢₙ+2
SIₓ=[(Yₓ−Yₓ₋₂)*0.4+(Yₓ−Yₓ₋₁)*0.6]/(Yₘₐₓ−Yₘᵢₙ)X=Xₘᵢₙ+2
SIₓ=(Yₓ−Yₓ₋₁)/(Yₘₐₓ−Yₘᵢₙ)X=Xₘᵢₙ+1
wherein Yₓ represents a value of a data item at an X coordinate position, Yₘₐₓ represents a maximum of the data item, Yₘᵢₙ represents a minimum of the data item, Xₘᵢₙ represents a minimum of the X coordinate, I=1, 2, . . . , M, and M is the number of data items;
(3.2) forming an M*N matrix for the break change rate by the break change rates for all the point locations, and performing normalization in unit of row, wherein M is the number of data items, and N is the number of point locations;
(3.3) identifying a noise point according to the matrix, specifically comprising:
(3.3.1) for each element S′iⱼ in the normalized matrix, calculating a difference coefficient Kᵢⱼ of the element, a value of the difference coefficient is an absolute value of a sum of differences between S′iⱼ and respective elements in a column in which this element S′iⱼ is located/(M−1), to form a matrix K, wherein i=1,2, . . . , M, and j=1,2, . . . , N;
(3.3.2) for each row in the matrix K, calculating an average K_{avg} and a maximum Kₘₐₓ, and the number of point locations for Kᵢⱼ in an interval [Kₘₐₓ−(Kₘₐₓ−K_{avg})/10,Kₘₐₓ]; if the number of point locations is larger than N/20, determining that there is no abnormal point location in this row, or else performing (3.3.3);
(3.3.3) extracting a point location in a case of Kᵢⱼ≥Kₘₐₓ; if the number of the extracted point locations is smaller than or equal to 3, marking the extracted point locations to be abnormal points and performing (3.3.4); if the number of the extracted point locations is larger than 3, ending the identifying; and
(3.3.4) in a case that Kₘₐₓ=Kₘₐₓ−(Kₘₐₓ−K_{avg})/100, removing data of an identified abnormal point location and performing (3.3.3); and
(3.4) substituting point location data of the noise point.

6. The method as claimed in claim 1, wherein the step (3.4) comprises: for an abnormal point location k, extracting data Y_{c} for a former normal point location and data Y_{d} for a next normal point location, to determine a data value of the abnormal point location k to be Yₖ=Y_{c}+(Y_{d}−Y_{c})*(k−c)/(d−c).

7. The method as claimed in claim 1, further comprising: removing a noise point by two-dimensional curve fitting and a curvature extremum peak-removing method.

8. The method as claimed in claim 1, wherein the step (4) further comprises: determining a supplementing order, specifically comprising:
(A) calculating a data completeness for each data item, wherein the data completeness comprises a ratio of the number of known data point locations which have been in the order to the total number of the point locations; and
(B) for a data item with the lowest completeness, selecting, from the to-be-supplemented data point locations of this data item, a point location with a smallest distance away from an existing data point location and adding to a task list; and re-calculating the data completeness of this data item, and performing (B) repeatedly, until the order determining is completed.
